(19) United States
(12) Patent Application Publication
(10) Pub. No.: US 2012/0138605 A1
(43) Pub. Date: Jun. 7, 2012

(54) WATERPROOF STORAGE DEVICE

(76) Inventor: DAVID ALAN GRUNDY, MERIDIAN, ID (US)

(21) Appl. No.: 13/155,092

(22) Filed: Jun. 7, 2011

Related U.S. Application Data
(60) Provisional application No. 61/397,265, filed on Jun. 8, 2010.

(51) Int. Cl. B65D 51/18; B62B 1/00; B65D 55/00; F16L 55/10; B65D 25/16; B65D 6/02

(52) U.S. Cl. 220/4.01; 220/256.1; 220/259.3; 220/495.06; 138/89; 280/47.17

(57) ABSTRACT

Presented is a waterproof storage container for above and below grade storage applications comprising a molded cavity with a large opening on one end, a threaded and gasketed inner lid, an outer id protecting the inner lid from moisture, backfill, and mechanical damage, enabling the burial or long term storage of firearms and other emergency supplies, a means to manufacture the same.

### FOUND RELATED PRIOR ART

| | | | |
|---|---|---|---|
| 5,207,345 | May 4, 1993 | Stewart et al. | 220/254 |
| 3,804,289 | Apr. 16, 1974 | Churan | 220/60 R |
| 3,510,023 | May 5, 1970 | F. E. Ullman et al | 220/60 |
| 3,515,306 | Jun. 2, 1970 | W. H. Roper et al | 220/60 |
| 4,628,827 | Apr. 30, 1984 | Litter | 109/50 |
| 3,945,329 | May 19, 1975 | Bywater | 109/68 |

### CROSS-REFERENCE TO RELATED APPLICATIONS

Prior Provisional Application:

Application Number: 61/397,265

Filing date: Jun. 8, 2010

Confirmation No. 5699

### BACKGROUND OF THE DISCLOSED TECHNOLOGY

In the mid 1960's, plastic buckets were developed with the intent of providing industry with an alternative to metal packaging containers. Plastic lids for these buckets were introduced to the market in 1971 and 1972. These products led to the now universally recognizable “5 gallon bucket” and it's variants used for the handling, shipping, and storage of both dry materials and liquids. While these buckets will vary in specific dimensions and features there is a great deal of similarity frequently allowing the lid of one manufacturer to be used on the bucket of another. This is true of the “5 gallon” family of products typically ranging from 3 to 7 gallons and using the same lid. It is also true of a “2 gallon” size family of buckets itself typically ranging from 1 to 4 gallons and using the same lid. This semi-standardization has led to the development of accessory products such as tool bags for hanging on the buckets, after market lids that incorporate swivel seats for dual service as stools, and even assemblies that use adapters to provide facilitated access to bucket contents with a threaded or screw-on lid. With the development of lid accessories such as this threaded lid assembly, the lids themselves become a semi-standard inviting creative design of the buckets to accommodate alternative utility such as squared configurations with side access for stackable storage of pet foods.

The “5-gallon buckets” and their variants are typically injection molded and most commonly of High Density Poly-Ethylene (HDPE). Alternatively shaped containers used with the lids tend to be blow-molded. While tough and sturdy for the intended use, they are thin walled and designed only for the stresses associated with the retention of the materials contained. They are intended for above ground use.

Current trends in individual preparedness have led to the use of these commonly available buckets for the storage of food, hardware, and other emergency supplies. Due to the nature of emergencies, it is of utmost importance that these supplies are protected from the time they are prepared until the time they are needed. They must be protected physically and from the elements, theft, and the nature of the emergency and/or intermediate emergencies themselves. One means to protect these supplies is burial in a suitable waterproof storage container. Existing buckets do not provide the structure required to resist the compressive forces of burial; nor do they provide the dimensions required for longer items as tools, collapsible shelters, and firearms. Larger burial vaults designed for human entry are expensive and difficult to install. The use of industrial pipe and fittings for long term storage purposes is common but larger sizes are costly and non-permanent sealing is difficult. There is a need for sturdy and robust waterproof storage containers with large access relative to their dimension in the plane of the access and of a variety of lengths or depths. In particular there is a need for such waterproof storage containers that will withstand the stresses associated with burial. There is a particular need for an elongated waterproof storage container with a small width dimension that will facilitate accommodation within modestly dimensioned holes and with a long axis suitable for the storage of rifles, shotguns, tent stakes, hand tools, and other similar items. Below ground installation is facilitated if holes can be dug with post-hole diggers or man operated augers without the need for heavy excavation equipment. There is also a need for a similar waterproof storage container configured with a lower profile, even as little as a few inches of interior depth, for the easy burial of smaller items such as jewelry, monies, documents, hand guns, and other valuables.

The ideal product will be sturdy to resist burial forces, have a straight body (not tapered as with typical 5-gallon buckets) for improved retention by backfill soils, be lightweight, have a large access opening, an easy means to seal, require no tools for subsequent access, be resistant to damage from foot or animal traffic when buried with adequate cover, have a low vapor permeation rate as achieved with polyethylene, and not contain corrosive chemistries. While not a requirement, adaptation for the accommodation of standardized or semi-standard bucket lids is an advantage. This product can be produced in a variety of diameters or cross-sectional shapes and sizes and in various lengths. The product will provided alternative service above ground and in form factors not commonly available for storage of dry and liquid goods with minimal footprint.

Rotational molding, also known as roto-molding, is a manufacturing method involving relatively inexpensive molds and reduced part cost for smaller production runs. It is also well suited to layered or multiple material wall cross-sections. The process includes the mold of appropriate material, usually aluminum, steel, or stainless steel, which is charged with a material such as low or high density polyethylene and usually in powdered form, and then heated while rotated on two axis' allowing all portions of the mold to pass through the charging material. As the interior of the mold is heated the material will melt to the surface of the mold growing in thickness as further heat is transferred through the mold and growing layer of material. When completed, the mold is cooled, the material is solidified, and the part can be removed. Adaptation of this manufacturing method to the fine geometries needed to allow use of the “5 gallon bucket” lid is a focus of this disclosed technology. One means discussed below for the design of a waterproof storage container suitable for burial is the use of corrugations in the profile, another is the use of a thicker wall section. Roto-molding is particularly suited to thick wall sections. One method to achieve thicker wall sections with less weight is to introduce a chemical foaming agent to the resin which results in a thicker wall for a given amount of material. Furthermore, this foaming agent (or foaming agent mixed with additional resin material) can be introduced mid-way through the molding process (usually by releasing the contents of a box located within the mold) to allow the solid outer skin formed on the mold to be followed by an expanded or foamed layer. As desired, a third layer of solid material can be applied over the top of the foamed layer. Various colors and surface finishes can be achieved including multicolor layers for a “granite” appearance. Also, the color of each layer can be varied. A white or other light interior color can be useful in the transmission of light from an open end down into the depths of the waterproof storage container for visibility of contents.

The nature of Roto-molding is such that cavities of dimensions approaching 2 times the wall thickness or less may exhibit bridging of materials in the molding process whereby cavities or pockets void of material may be formed even if an exterior skin is achieved. Smaller cavities less than 2 times the wall thickness and with depths exceeding 2 times the wall thickness may not skin over completely leaving an irregular surface finish and gaps in the outer profile of the part. The fine geometries required to reproduce a profile similar to a 5-gallon bucket are subject to this challenge. To overcome this limitation of the roto-molding process, secondary machining operations can be used to trim a part to a desired finished dimension.

As commonly available PVC and ABS pipes are frequently used ion conjunction with closure fittings to form sealed waterproof storage containers useful in caching applications, it is also desirable to be able to apply the technologies discussed herein to plastic pipe and waterproof storage containers fabricated from plastic pipe. This is accomplished by use of an adapter to configure the end of a plastic pipe section to have such desirable features as a lid that does not require tools to install or remove and which is protected from damage with an outer lid as discussed above.

Elements of the disclosed technology are considered novel such as the concept for addressing the need, the combination of technologies and components, and methods for manufacture.

Accordingly, it is an object of the present disclosed technology to provide a waterproof storage container suitable for above and below ground use for the storage of wet or dry goods.

Another object of the present disclosed technology is to provide a means to accommodate the use of “standardized” or “semi-standardized” bucket lids on the waterproof storage container.

Still another object of the present disclosed technology is to provide a means to manufacture the waterproof storage container.

Another object of the present disclosed technology is to provide a waterproof storage container whose principal features can be applied to a variety of form factors, lengths, widths, colors, shapes, and customized for specific end uses.

It is yet another object of the present disclosed technology to provide a waterproof storage container with a means to resist the floating uplift generated when a vessel is buried in material that is subsequently saturated with water.

Yet another object of the present disclosed technology is to provide a means to recover stored materials that may otherwise, while in use, be positioned out of reach within the waterproof storage container, this through the use of specialized storage baskets with elongated handles.

An additional object of the present disclosed technology is to provide the means for the use of screws driven into the interior wall of the waterproof storage container without compromise of the integrity of the waterproof storage container for the purpose of attaching accessories which may include hooks, bars, or other means for the hanging of items or secondary containers from points within easy reach of the access opening of the waterproof storage container.

It is a further object of the present disclosed technology to provide a means to protect the lid and access to the waterproof storage container from physical damage while in use or excavation for access when buried and to protect the gasket or seals of the lid or related components from the gravity flow of moisture.

Another object of the present disclosed technology is to provide a means to facilitate manual transport of the waterproof storage container through the use of a wheel and optionally a handle assembly which would attach readily to the body of the waterproof storage container via molded accommodations, said wheel and handle assemblies being stowable within the waterproof storage container when not in use.

Yet another object of the present disclosed technology is to provide a means to control access to the contents of the waterproof storage container by securing and outer lid, which protects the lid, to the body of the Waterproof storage container.

### BRIEF SUMMARY OF THE DISCLOSED TECHNOLOGY

The present disclosed technology provides a waterproof storage container for the protection of supplies and other items in short and long term applications both above and below grade and in static and mobile applications. Presented is a generally cylindrical container body with a lower rim portion having a closed bottom and an upper rim portion, said upper rim having an opening similar to the container body inside diameter.

The upper rim portion is configured to accommodate an inner lid removably attached. This inner lid is protected by an outer lid which fits over the inner lid as installed on the upper rim portion and which outer lid installs with a slip fit over the same upper rim portion to bear on a weight bearing band circumvolving the upper rim portion such that loads applied to the outer lid are transferred to the container body and not to the inner lid.

In a preferred embodiment of the waterproof storage container a strap groove is located below the weight bearing band for the purpose of attachment of accessories such as a lifting strap

In a variation of this embodiment the upper rim portion is attached to the remaining portion of the container body by means of a bonded slit fit.

Another embodiment of the present invention comprises a similar generally cylindrical container with said closed lower rim portion and open upper rim portion, a weight bearing band along with an outer lid, and a strap groove, together with an inner lid configured for threaded attachment to the upper rim portion and where said inner lid is of substantially the same diameter as the inside diameter of the container body. This embodiment can be further equipped with a plurality of object hanging points mounted to the inner surface of the container body. To facilitate attachment of hardware a thickened container body region is accomplished with the weight bearing band in conjunction with an interior band. This embodiment can be further modified with an upper rim portion configured for the attachment of a snap fit container lid, or with the use of an intermediate threaded adapted snap fit to the upper rim portion whereby a threaded inner lid can be use. The upper rim portion can also be configured for a slip fit of the outer lid.

These embodiments can make use of multiple wall layers in which one or more additional layers can be attached to the inner surface of the container body at the time of fabrication. At least one of these layers can be of foamed material for improved structural properties with limited additional weight. The innermost layer can be of lighter material for improved light reflectance and visibility within the container body. The waterproof storage container of this embodiment can be equipped with a locking ring comprised of a flexible sheet metal band with tabs along a top edge for capture of the outer lid and tabs along the lower edge to engage the strap groove and thus securing the outer lid to the container body when the opposing ends of the locking ring are engaged one with the other.

This embodiment can be configured for the use with a snap fit inner lid or threaded adapter by the molding of a perimeter protrusion circumvolving the outer rim of the distal portion of the upper rim portion while the inner surface of the same distal portion is established with a rotary cutting tool passed around the desired finished said inner surface at a fixed distance from the outer surface of the said perimeter protrusion.

A preferred embodiment comprises the use of a detachable wheel assembly comprising a pair of wheels mounted to a clamping band attached to the container body. This wheel assembly can be further enhanced with the attachment of the wheel assembly proximal to the lower rim portion of the container body and a separate detachable handle assembly proximal to the upper rim portion of the container body, and where both detachable assemblies can be stowed within the said container body.

The above embodiments can be used together with an anti-corrosion bag of dimensions suitable to accommodate the entire contents of the container body and of one or more layers where the innermost layer is of a poly material infused with an outgassing anti-corrosion chemistry. A further enhancement of the embodiment is a basket device used for retrieval of items as may be out of reach within the waterproof storage container.

The upper rim portion of this embodiment can be separate from a remaining portion of the container body with the container body thus assembled with a bonded slip fit for the upper rim portion to the said remaining portion.

Another preferred embodiment of the disclosed technology is comprised of an elongated container body with a closed lower rim portion, an upper rim portion for attachment of a snap fit bucket lid, a lower perimeter groove together with a detachable wheel assembly, an strap groove for a removable handle assembly, and where both removable assemblies are stowable within the container body.

Yet another preferred embodiment of the disclosed technology comprises a generally cylindrical upper rim portion identified as a cylindrical pipe closure and configured on a first end to accommodate an inner lid in the form of a snap fit bucket lid. This inner lid is protected by an outer lid which fits over the inner lid as installed on the upper rim portion and which outer lid installs with a slip fit over the same upper rim portion to bear on a weight bearing band circumvolving the upper rim portion such that loads applied to the outer lid are transferred to the container body and not to the inner lid. The said cylindrical pipe closure has a second end configured with a slip fit connection for use to adapt the end of a pipe section for closure with said snap fit bucket lid. With one end of a pipe section fitted to the cylindrical pipe closure and the other end of the said pipe section closed with a slip fitting, the resulting assembly comprises a waterproof storage container.

### BRIEF DESCRIPTION OF THE DRAWINGS

FIG. 1 is a side view of a preferred embodiment shown as an exploded diagram of component parts.

FIG. 2 is a side and top view of a principal component identified as the waterproof storage container body and shown with cut-aways.

FIG. 3 is a section view detail of the upper portion of one edge of the waterproof storage container body and serves as an expanded view of a cut-away detail in FIG. 2.

FIG. 4 is a section view detail as in FIG. 3 identifying additional features referenced in the disclosure.

FIG. 5 shows three section views of the upper section of the upper rim portion of the waterproof storage container body illustrating first, a secondary machining process to remove a portion of the as molded part to establish access to the waterproof storage container, second, the same part with the access established, and third, the same part with an inner lid attached and illustrating a typical gasket use.

FIG. 6 shows a the same detail as in FIG. 3 and FIG. 4 and with an accessory attached showing the placement of a fastener into a thickened container body region designed and intended to receive such fasteners.

FIG. 7 shows an accessory hook that can be used and attached with a fastener in a fashion similar to the attachment method shown in FIG. 6.

FIG. 8 shows the bottom, side, and top view of an outer lid that covers and protects the inner lid or threaded inner lid and threaded adapter, and which serves as a closure for the waterproof storage container.

FIG. 9 shows an assembled waterproof storage container set in an excavated hole to illustrate a typical below ground installation.

FIG. 10 is a side view of an alternative embodiment characterized by more substantial corrugations of the side wall of the waterproof storage container.

FIG. 11 shows the side and end views of a molded accessory basket set as the molded part would appear upon removal from a mold and prior to secondary process(s) to separate the two baskets.

FIG. 12 is shows two baskets separated as they would appear after secondary processing from the as-molded condition shown in FIG. 11 and further shows how those baskets would appear when stacked.

FIG. 13 shows the open end of the waterproof storage container with a typical gasketed inner lid installed and the outer lid installed to protect the inner lid.

FIG. 14 shows a typical protective outer lid installed on a typical waterproof storage container which outer lid is secured to the container body with a locking ring for controlled access to the waterproof storage container independent of the inner lid.

FIG. 15 shows a low profile embodiment of the disclosed technology suitable for the storage of smaller quantities of materials or valuables such as jewelry, monies, documents, and handguns.

FIG. 16 shows an embodiment equipped with a detachable wheel assembly and handle assembly for ease of transport.

FIG. 17 shows a pipe closure device allowing for the closure of pipe and similar tubular conduits with snap fit bucket lids.

FIG. 18 shows a pipe closure device used to assemble a waterproof storage container in a preferred embodiment.

### DETAILED DESCRIPTION OF THE DISCLOSED TECHNOLOGY

One embodiment of the disclosed technology provides a container body 1 consisting of substantially upright walls with a lower rim portion 71 closed at the bottom and an upper rim portion 70 open at the top with an overall assembled height of approximately 48 inches to accommodate most long guns (rifles and shotguns) and fitting in a 48 inch box in order to stack economically on a standard 40 inch by 48″ pallet. As the size of an object to be stored is limited by the size of the access 2 or opening (herinafter “access”) the size of the interior of the Waterproof storage container (which may be round, square, or other shaped but hereinafter referred to as “diameter” for convenience), the inside diameter 3 identified as the distance between opposing inner surfaces, is desired to be similarly sized and the outside diameter 4 is desired to be as small as possible to minimize the size of the hole that must be dug for buried use. In this preferred embodiment the outside diameter 4 (the distance between opposing outer surfaces) is sized similar to the standardized “5-gallon bucket” lid at approximately 13 inches. In this preferred embodiment a wall thickness of approximately ¼″ of linear low density polyethylene is used. In this embodiment the threaded adapter 5 and inner lid 6 of the company Gamma Squared, currently marketed as the Gamma Seal Lid and in its “5-gallon” configuration, is accommodated. The present Waterproof storage container will preferably be equipped with a recess 7 in the outer wall to serve as a finger grip and as a strap groove for a lifting strap within a practical, and preferably 3 to 4 inch, distance 8 from the top of the Waterproof storage container assembly for ease of handling when placing or removing from a hole 9 in the ground. This recess is preferably also located in close proximity to the reduced outside diameter 10 for the lid attachment which will create a cavity of such dimensions that the Roto-molded process will tend to completely fill the cavity making use of the natural filling qualities of the plastics in cavities of such dimensions and thereby creating a thickened container body region 12. More preferably the depth 13 of this cavity will be no less than the wall thickness 15 of the container body 1 and the width 14 of this cavity will be approximately twice the wall thickness 15. This filled cavity will create a thickened container body region 12 ideal to receive fasteners 16 such as sheet metal screws for the attachment of accessories such as hooks 18 or bars 17 for the hanging of stored items or secondary waterproof storage containers within the container body 1, for the tie-off of retrieval lanyards attached to items stored out of reach at the bottom of the water proof storage container, or for the attachment of specific stored items. In a preferred embodiment utilizing the thickened container body region 12 with width 14 of 1″ and depth 13 of ½″, a ½″ wall thickness is desired. This can accomplished by laying down the first ⅛″ of an equivalent ¼″ of material prior to adding a foaming agent expanding the remaining ⅛″ to about ⅜″ for a total wall thickness 15 of ½″.

The present disclosed technology further preferably includes a raised interior portion 19 of the bottom of the container body 1 so that any distortion of the bottom will not result in an unstable condition if stored on a flat surface. The perimeter of the base would further include a lower portion or portions 21 around the perimeter as a bearing foot. Said bearing foot would preferably include cavities 22 formed by pins at the time of molding for the receipt of screws such as sheet metal screws or inserts 20 positioned by the mold at the time of molding for receipt of screws such as machine screws of a length long enough for optimal engagement of the thickened material while short enough so as not to penetrate the outer wall. These screw attachment points would serve for the attachment of a stabilizing base for above ground use or accessories such as anchoring protrusions to further resist floating uplift in below ground use.

The present disclosed technology still further preferably includes a recess 41 as a means to anchor the container body 1. Most preferably, this recess is located proximal to the base and at a distance approximately twice the wall thickness in order to form a solid mass of material 42 for strength. The resulting protrusion of the mass 42 can be used with clamps to bolt or otherwise affix the Waterproof storage container 1 to a flat surface as in a pantry, garage, or outdoor slab. In a buried application, the mass 42 and recess 41 provide additional anchoring and resistance to floating lift forces that may result from saturated soils. In a preferable buried installation, a concrete material may be poured into and around the container body 1 which, when cured, will serve to positively anchor the Waterproof storage container within the hole by locking the recess 41 and mass 42 to the contour of the excavated hole.

Manufacture of the present disclosed technology is facilitated by the roto-molding process. A preferred embodiment consists of a solid skin exterior 23 followed with the introduction of a foaming agent and the laying of an expanded or foamed layer 24 of similar material for an overall thickness in excess of that which would be achieved with the same weight of material absent the foaming agent. Material that would result in a ¼″ of wall thickness can then be caused to produce a wall thickness of ½″ or more with a resulting product of similar weight and additional strength, all while preserving the protection of the contents of the container body 1 from intrusion. In this preferred embodiment, the mold contains the desired profile 11 for interface with the lid adapter 5. As the charged (with material) mold is rotated in the oven, the material is allowed to build a solid layer following the profile and filling the protrusion 25 that serves to lock the inner lid 6 or threaded adapter 5. After the required buildup of solid material 23, either the foaming agent alone or a premixed batch of foaming agent and fresh material is introduced to the mold and the foamed layer 24 is allowed to build up, this layer followed by any subsequent layers. Following cool down and removal from the mold, excess material is machined to reveal the desired finished inside diameter 26 of the neck profile 11. This can be accomplished most economically using a hand held router 28 equipped with a bearing 29 and following a template 27 fit to the neck profile 11 of the container body 1. In this fashion, the profile required for the secure attachment of the lid or lid adapter is achieved and with the strength of the solid material 23. The face 30 (the outer perimeter region of surface 34) can be as molded or machined as desired to achieve a flat surface for an optimal seal against any gasket 31 contained in the inner lid 32 or threaded adapter 5. This is an important feature marking a superior interface compared to other storage waterproof storage containers currently marketed with irregular surfaces at the gasket interface. Preferably, the mold will include a flat end for the surface 34 in the vicinity of the sealing surface 30 without joint or seam so that this sealing surface 30 will be fully formed upon removal from the mold and without mold flash as would result from a longitudinally split mold with seams in the ends of the mold. The flat end eliminates the need for secondary processing and limits the required machining to that necessary to establish the finished inside diameter 26.

The present disclosed technology further preferably includes an outer lid 35 to protect the inner lid 32 or threaded inner lid 6 and threaded adapter 5. Industry standard lids, while functional, may not be as robust as the rest of the Waterproof storage container. In order to protect the inner lid 32 or threaded inner lid 6 and threaded adapter 5 from physical damage and in order to direct moisture away from the gasketed or un-gasketed closure points, a outer lid 35 with an outside diameter similar to the outside diameter 4 of the container body 1 is positioned to entirely cover the lid on the top and sides. Preferably, this outer lid 35 is located by a shoulder 36. This shoulder 36 helps to carry any side loading of the outer lid 35 which might otherwise be transferred to the inner lid 32 or threaded inner lid 6 and threaded adapter 5 where such loading might otherwise damage the lid or lid assembly or distort the shape and therefore compromise the performance of the gasket(s) 31. Vertical loads applied to the outer lid 35 are transferred through to the wall of the container body 1 via the lower rim of outer lid 35 bearing on a weight bearing band 59 formed in the wall of the container body 1. The outer lid is preferably equipped with stiffening ribs 37 to minimize distortion of the outer lid due to loading from above resulting from covering soils, human or animal traffic, snow loads, or other similar forces. In burial applications, this outer lid 35 is of particular use to protect the inner lid 32 or threaded inner lid 6 and threaded adapter 5 from inadvertent damage resulting from a recovery excavation as might be accomplished with a shovel.

In the present preferred embodiment with the “5 gallon” lid accommodation, modern sporting firearms such as the Smith and Wesson SR15 assembled and equipped with a typical sporting scope can be accommodated dimensionally. As it is desirable to provide storage options requiring less space and for those with lower profile long guns such as common bolt action rifles like the Smith and Wesson I-bolt, the above described preferred embodiment can be adapted in a similarly preferred embodiment to the use of the smaller 2-gallon Gamma Seal Lid or similar smaller bucket lids allowing for accommodation of such assembled and scoped rifles while necessitating a smaller hole for burial applications. In this similarly preferred embodiment the outside diameter is reduced to approximately 10-11 inches. Intermediate, larger, and smaller sizes are envisioned and should be considered within the scope of this disclosed technology.

In the preferred embodiments described, it is further preferred that the essential features be incorporated into waterproof storage containers of various lengths. Careful design of the mold can allow for facilitated manufacture of various lengths with natural break points aligned with exterior features of the waterproof storage container such as points of change in outside diameter 38 as might be repeated at intervals along the length of the waterproof storage container.

In a preferred embodiment, the exterior of the waterproof storage container is varied to provide aesthetic appeal and additional function. The outside diameter 4 is varied to create corrugations which serve to provide grip for backfilled materials to resist upward floating lift in saturated soils and to provide additional strength. The walls of the mold can be made thinner at the raised portions 39 of the outside diameter to encourage additional build of material at these points effectively creating reinforcing rings at various points along the length of the Waterproof storage container. The texture of the raised 39 and depressed 40 areas can be varied for additional appeal.

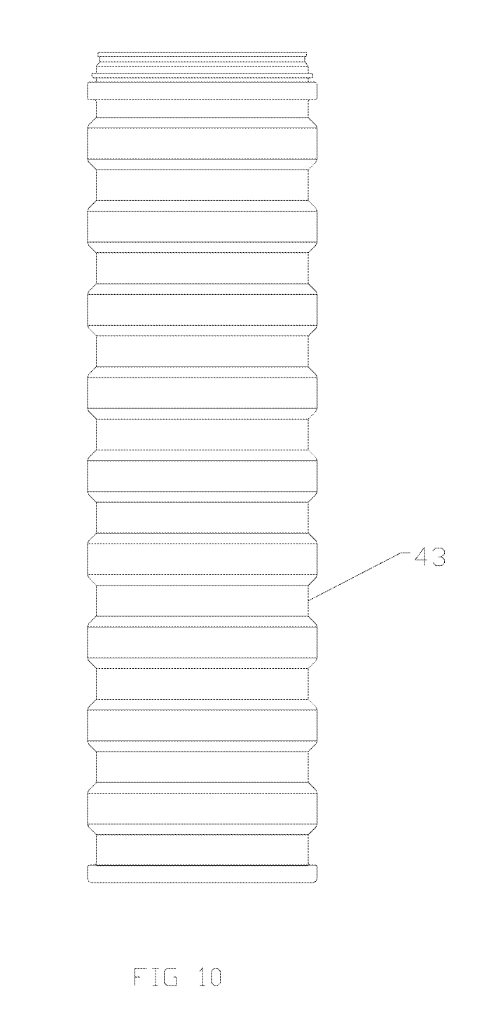

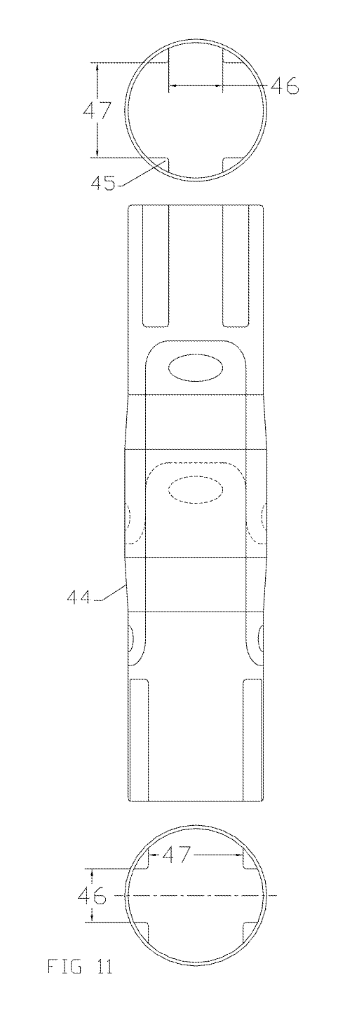

In another preferred embodiment of the present disclosed technology, dramatic corrugations 43 such as squared, hexagonal, or curved similar to metal or plastic culvert are used for strength with the added advantages of allowing for a thinner wall 15 and additional anchoring when buried to resist upward forces resulting from saturated soils as the waterproof storage container tries to float. This embodiment is particularly suited to solid walls without foaming agents as might be necessitated to reduce cost or if construction materials are desired that do not lend themselves to use with foaming agents. A generally hexagonal corrugation of this preferred embodiment is shown in FIG. 10. This configuration of the disclosed technology can lend itself in thinner wall thicknesses to alternative molding processes such as blow molding.

Various preferred embodiments involve finish and coloring adapted to specific end uses. Black pigments are inexpensive and can provide additional UV light protection. Certain dark greens are well suited for the blocking of light transmission which serves to inhibit biological growth as would be problematic with potable water storage. Greens and tans as with military shades of these colors can be an aid to marketing and sales and functional as camoflage in outdoor applications. Camoflage can be further enhanced with the introduction of secondary color(s) to a solid base color to achieve a mottled look. This technique can also be applied using whites, grays, and/or blacks to achieve simulated granite finishes. Oranges can indicate safety items or emergency relief agency supplies. Whites can be suited to indoor use such as in pantries or garages. Food grade resins can be used for direct food contact. White can be used on interior layers to aid in light reflectance and visibility of contents.

It is another preferred embodiment of the disclosed technology that the waterproof storage container accommodate the use of baskets as shown in FIGS. 11 & 12 used for the separation and retrieval of stored items. Such baskets can be manufactured using roto-molding methods with an as molded part 44 yielding two baskets of various handle lengths with each mold cycle. In the preferred embodiment, vertical detents 45 in the basket are arranged in opposing pairs of unequal spacing 46 & 47 such that when one basket is rotated 90 degrees with respect to a second basket, the first basket 48 will stack on the second basket 49. With the handles trimmed at differing lengths, the baskets, when stacked within the Waterproof storage container, present their handles at similar elevations and within easy reach of the access 2. In a further preferred embodiment of the disclosed technology, the disk that is removed from surface 34 at the end of the Waterproof storage container to form the access 2 opening when the inside diameter 26 of the neck is machined is salvaged and trimmed to form a lid for the uppermost basket and thereby serving as a shelf 50 for additional items stored on top of the uppermost basket and potentially within reach from the access 2. In the absence of the use of any baskets, this same disk 50 can be used at the bottom of the Waterproof storage container as a reinforcing layer and protection of the bottom of the Waterproof storage container against damage from dropped items.

In another preferred embodiment of the disclosed technology, the profile of the neck profile 11 of the waterproof storage container is configured for the bonding of an adapter 5 similar to the Gamma Seal Lid but without reliance on a gasket 31, the bonding and seal being accomplished by adhesive or heat fusion of the container body to the similar material of the adapter.

In yet another embodiment of the disclosed technology, the neck profile 11 of the container body is formed with integral threads for accommodation of a separately formed threaded closure.

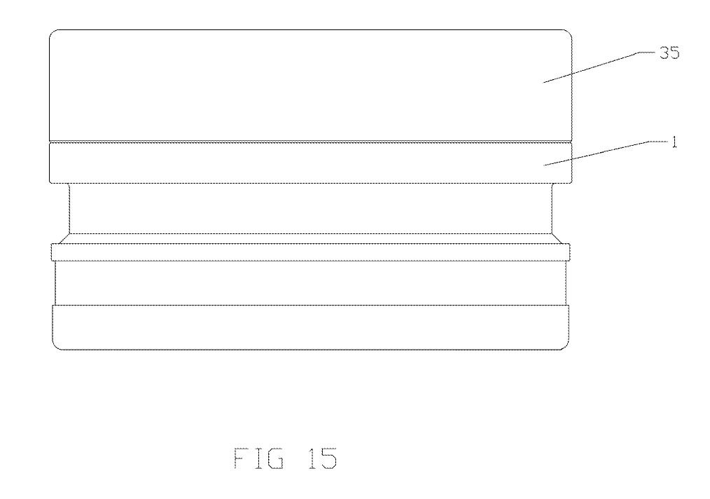

In a preferred embodiment of the disclosed technology, a means is provided for the lockable securing of the outer lid 35 to the container body 1 thereby controlling access independent of the inner lid 32. Referring to FIG. 14, a preferred method is to provide a locking ring 63, preferably of stainless steel or if economy dictates, treated steel or steel alloy, the edges of which are lined with tabs 64 which are folded to an angle with respect to the surface of the plate. The width 65 of these tabs is limited so as not to limit the flexibility of the plate. The space between the tabs is adequate to span the distance from the top of the Cap 35 to the top of the strap groove 7. Opposing ends of the plate are equipped, one with the actuating portion of a latch 60, preferably a draw latch, and the other with the catch 62 or equivalent. The plate is wrapped around the top of the Waterproof storage container assembly capturing and securing the Cap 35 to the Waterproof storage container 1 and the latch 60 and 62 is engaged. A latch equipped with a perforated tab 61 is preferred and allows for the use of a conventional locking device such as a keyed padlock or combination lock.

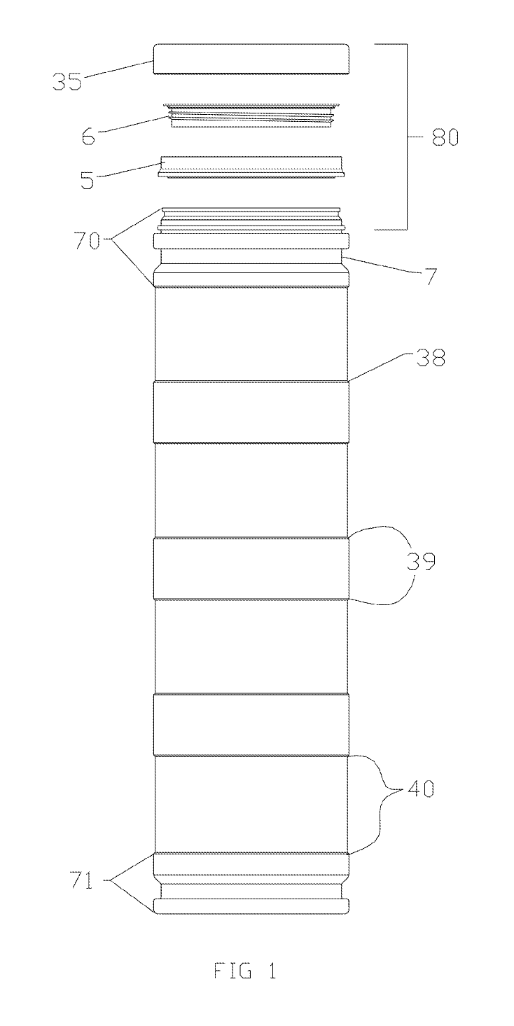

FIG. 1 shows a preferred embodiment of the disclosed technology showing a closed lower rim portion 71 of the container body, in this embodiment shown with alternating raised sections 39 and lowered sections 40 for aesthetic, strength, and buried retention purposes. Transition points 38 between raised and lowered sections can hide mold parting lines and facilitate modular stacking of mold sections. The top of the container body is identified as the upper rim portion 70. The strap groove 7 which doubles as a hand grip is shown. An exploded assembly 80 of the waterproof storage container is shown comprising a threaded adapter 5, a threaded inner lid 6, and an outer lid 35.

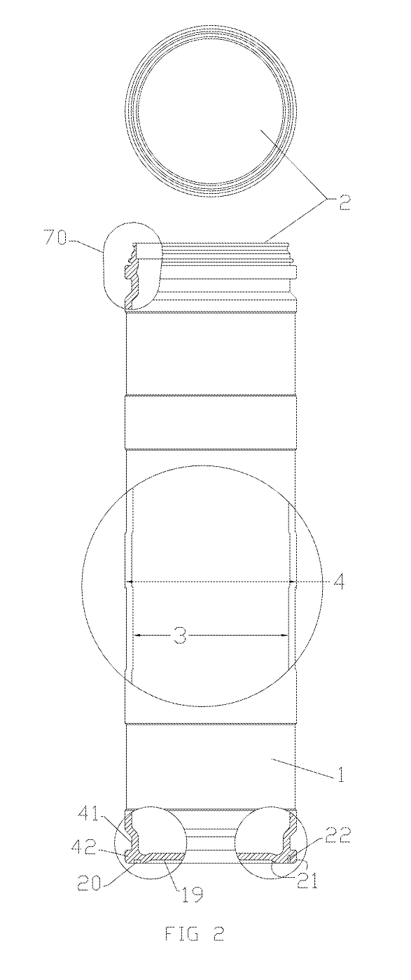

FIG. 2 shows the container body 1 with a cutaway for visibility of the inside dimension and inner surfaces 3 and the outside dimensions and outer surfaces 4. Another cutaway shows the profile of the upper rim portion 70. The open end 2 of the container body 1 is identified. The lower rim portion is also cutaway to reveal other preferred embodiment features as a lower groove 41 anchoring in soils or backfill media in burried applications, wheel assembly attachment in transit, strap attachment for suspension as from a shoulder strap or lanyard, and clamping as to a surface for stability in static applications. Also shown are a perimeter protrusion 42 for anchoring, fastener attachment points 20 and 22 for mounting of anchoring and stability accessories, recess 19 to limit warpage of the closed bottom from interfering with stability when standing on a flat surface, and the perimeter protrusion or foot 21 for contact with the supporting surface.

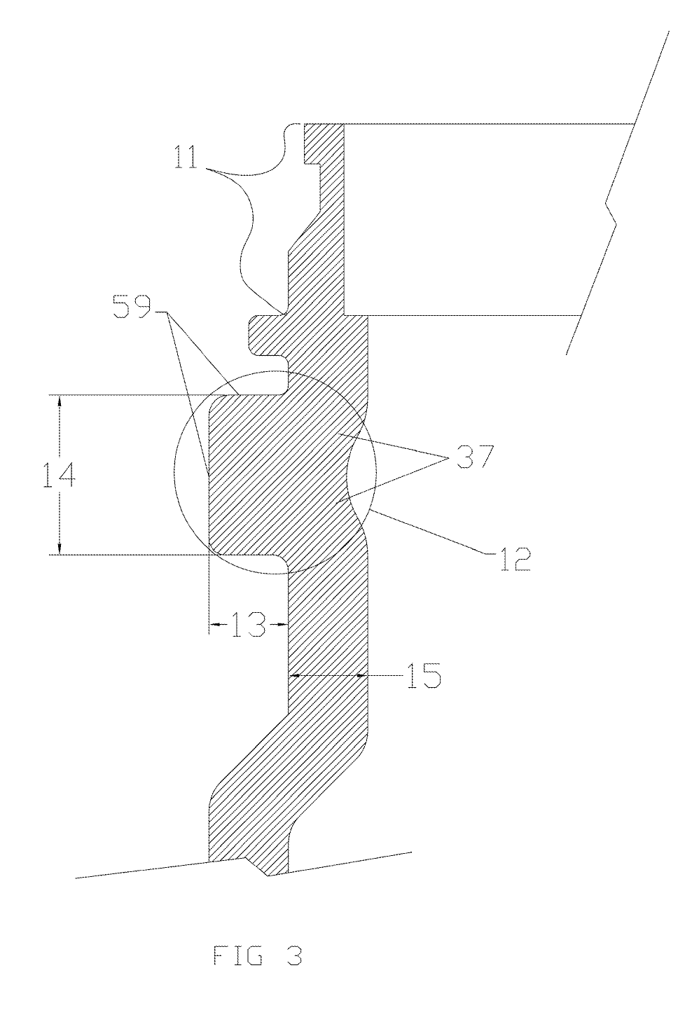

FIG. 3 shows a detail of the sectional view 70 of FIG. 2 and illustrates further detail of a preferred embodiment of the upper rim portion of the container body. Shown is the distal portion 11 of the upper rim portion of the container body 1, which distal portion 11 establishes the profile for the attachment of a snap action lip such as a typical commercially available industrial container bucket lid. A preferred embodiment is to use a Gamma Seal by Gamma2 of Carlsbad, Calif., and available for standard 5-gallon bucket as model 5.0 and for 2-gallon buckets as model 2.0. An outer protrusion forms a weight bearing band 59 cicumvolving the perimeter of the upper rim portion 70 has a longitudinal dimension or width 14 together with a radial differential dimension or depth 13 serving several purposes. The lower edge of the outer lid 35 bears against the top surface of said weight bearing band 59. The bottom surface of said weight bearing band 59 serves as the distal boundary of the strap groove 7 already identified and also forms a finger grip surface for grasping the waterproof storage container from above. Together dimensions 13 and 14 are defined by a cavity in the mold that can be filled with material such that the weight bearing band 59 is combined with an interior band 37 of built up material to form a thickened container body region 12. The container body 1 wall thickness 15 is also shown.

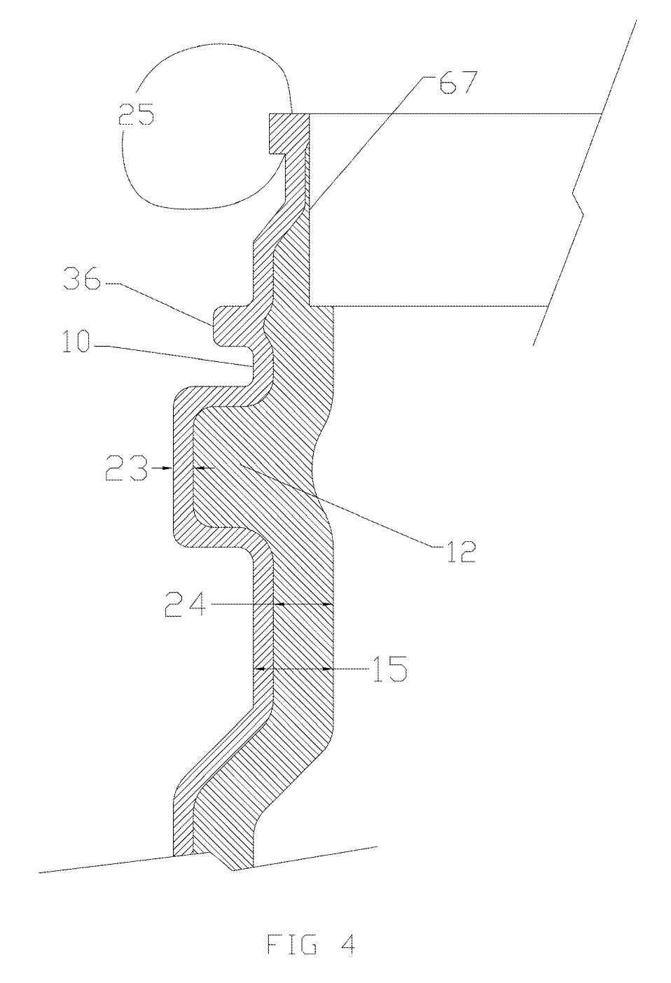

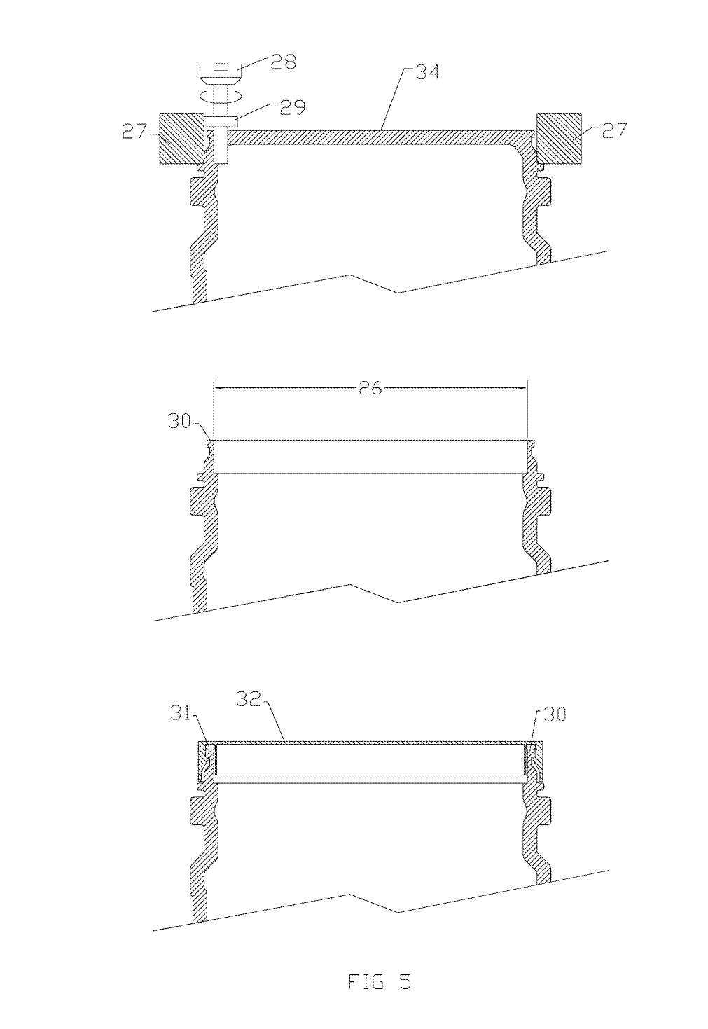

FIG. 4 shows additional features and embodiments of the upper rim portion 70. The distal portion of the upper rim portion 70 is further illustrated showing an outer protrusion 25 cicumvolving the distal portion of the upper rim portion 70 of the container body 1, said outer protrusion 25 serving as the profile to which a snap fit inner lid 32 (FIG. 5) or threaded adapter 5 (FIG. 1) will lock. The inner surface 67 of the distal portion of the upper rim portion 70 is also shown at a finished dimension following a secondary operation to trip the molded container body 1. Also shown is the wall profile of a preferred embodiment where an outer layer 23 of a first material built up with an inner layer 15 of a second material with this embodiment representing a solid outer layer 23 with a foamed inner layer 15 which inner layer adds structural integrity with minimal additional mass and while filling the mold cavity to create the thickened container body region 12. Drainage groove 10 assists in directing water around the perimeter of the container body 1 in those applications where the waterproof storage container is inclined at some angle from vertical by any amount less than but approaching 90 degrees. The groove is established by that gap between the weight bearing band 59 and the perimeter slit fit protrusion 36 which slip fit protrusion serves to guide and support the outer lid 35 transferring a portion if not all of the side loads applied to the outer lid 35 through to the container body 1 rather than to the inner lid 32.

FIG. 5 shows three sectional views of the upper rim portion 70 previously identified. The upper most shows the removal of excess molded material of surface 34 by means of a rotary cutting tool 28 passed around the inner perimeter of the distal portion of the upper rim portion at a fixed distance from the outer protrusion 25 (FIG. 4) by means of a guide template either indexed on the surface shown or on the outer protrusion 25 itself and with the cutting tool following the template by means of a guiding bearing 29. The middle view shows the same upper rim portion 70 after removal of the excess material of surface 34 leaving only the sealing surface 30 against which a gasket can be compressed by the threaded adapter 5 (FIG. 1) or inner lid 32 as shown in the lower view. A compressed gasket 31 in the form of an o-ring is also shown in the lower view.

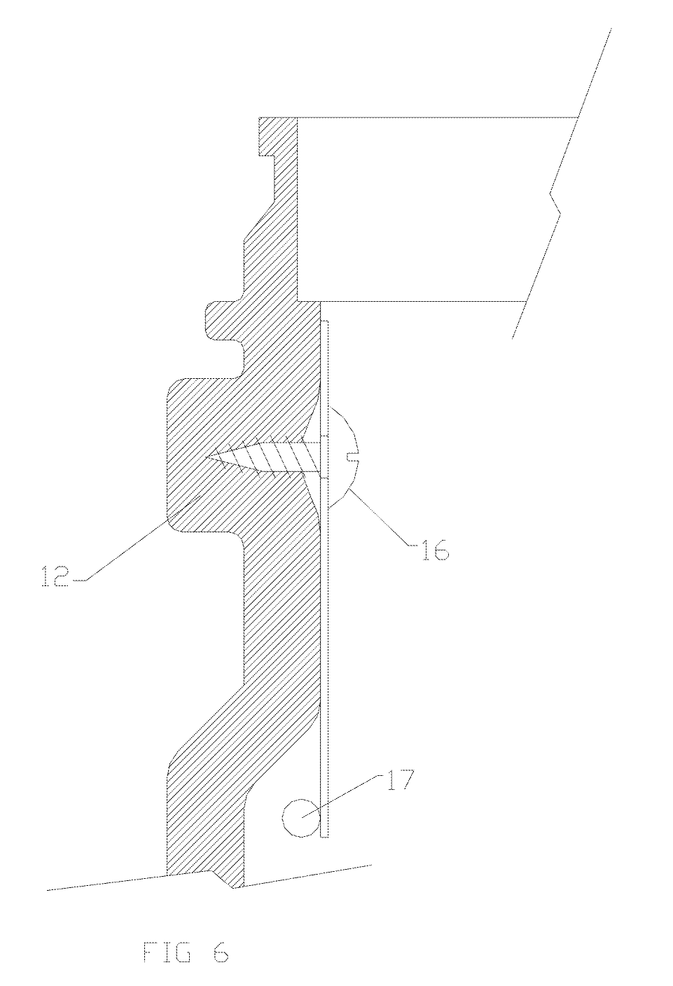

FIG. 6 shows a piece of hardware 16 in the form of a screw fastener installed into the thickened container body region 12 for the purpose of mounting a hanger device 17 for the tie off of retrieval wires or strings used for the lowering and raising of stored supplied that might otherwise be out of reach in the waterproof storage container.

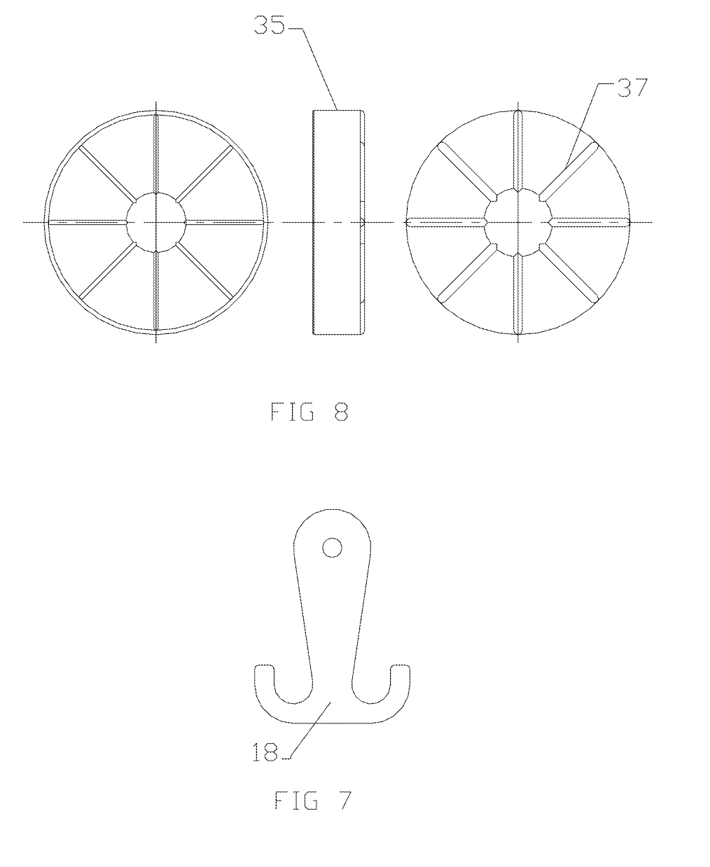

FIG. 7 shows an alternative hook that might be installed with the fastener illustrated in FIG. 6 for the hanging or tie off of stored content. A preferred embodiment of such a hook would be a stamping of sheet metal with sharp edges removed.

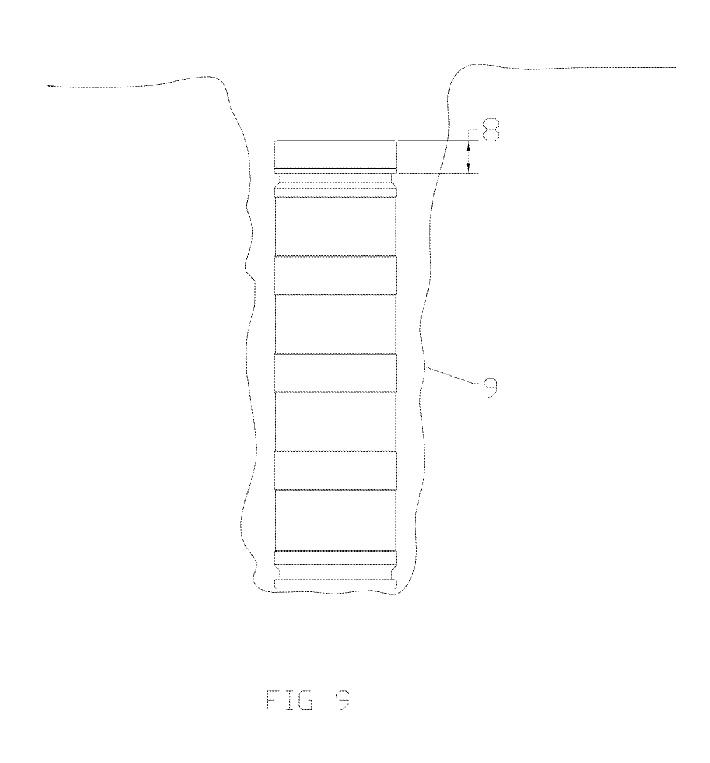

FIG. 8 shows a preferred embodiment of an outer cap 35. The left view shows an underside or interior view while the right view shows the top. The reinforcing ribs 37 provide additional strength to resist the forces of backfill in a burial application. The outer lid 35 serves the purpose of protecting the inner lid 32 or threaded adapter 5 from water, backfill, and mechanical damage as from a shovel in recovery. It can also be secured to the container body 1 as illustrated in FIG. 14.

FIG. 9 shows an illustration of a burial application with an excavated hole 9 containing a preferred embodiment of the waterproof storage container. Dimension 8 illustrates a useful location of the strap groove 7 as a finger grip for installing and removing the waterproof storage container from the hole 9.

FIG. 10 shows another embodiment of the container body 1 in which the generally cylindrical container body is corrugated for additional strength. Such wall configurations can allow for thinner wall thicknesses and alternative manufacturing methods such as blow molding. The small dimension 43 becomes the controlling dimension for the size of items to be stored and is preferably no less than the opening dimension.

FIG. 11 shows an as molded view of a pair of baskets 44 in a preferred embodiment which can be used together with the waterproof storage container for the placement and retrieval of stored items within. This pair of baskets would be separated along molded witness lines. Notches 45 set at unequal dimensions 46 and 47 created support surfaces on the top of the notches 45 for one basket to be stacked upon the other when rotated 90 degrees with respect to one another. The handles as identified in subsequent views can be trimmed to different lengths to accommodate the particular dimensions of the waterproof storage container.

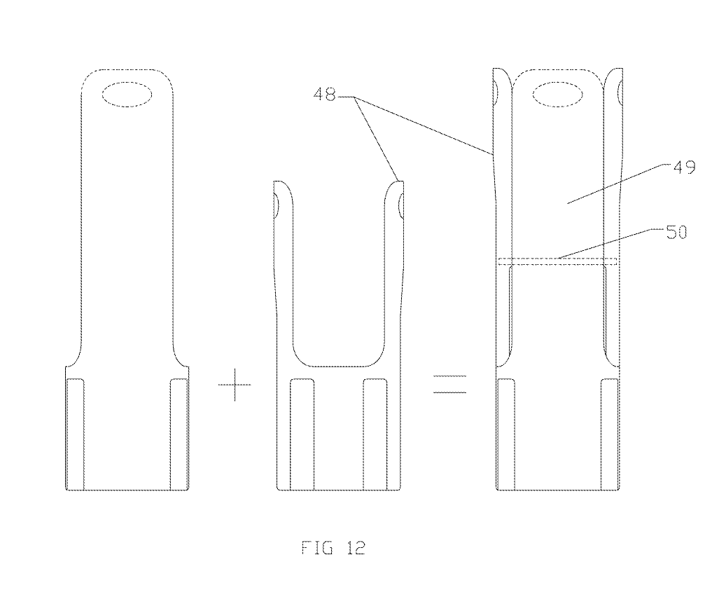

FIG. 12 shows a pair of baskets 49, one with short handles 48 and one with long handles. Together they form the assembly shown at the right. An optional shelf 50 is also shown to allow further stacking of stored items. It is noted that the diameter of the baskets shown is such that the lower portion will enter the opening of the preferred embodiment using a threaded adapter 5 while the flexible handles are at a larger width to stand upright along the inner wall of the container body 1 until drawn together to be grasped by one hand for removal. The smaller diameter of the lower portion of the basket also serves the purpose of maintaining clearance for elongated items such as tent stakes and rifle barrels to extend down along the side of the baskets.

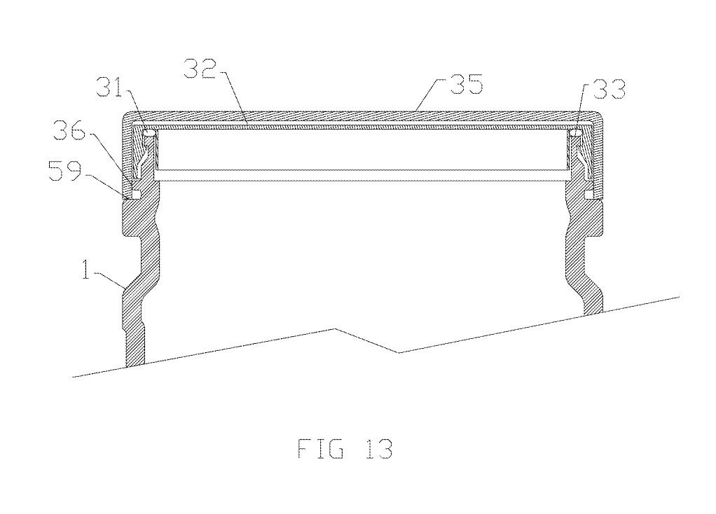

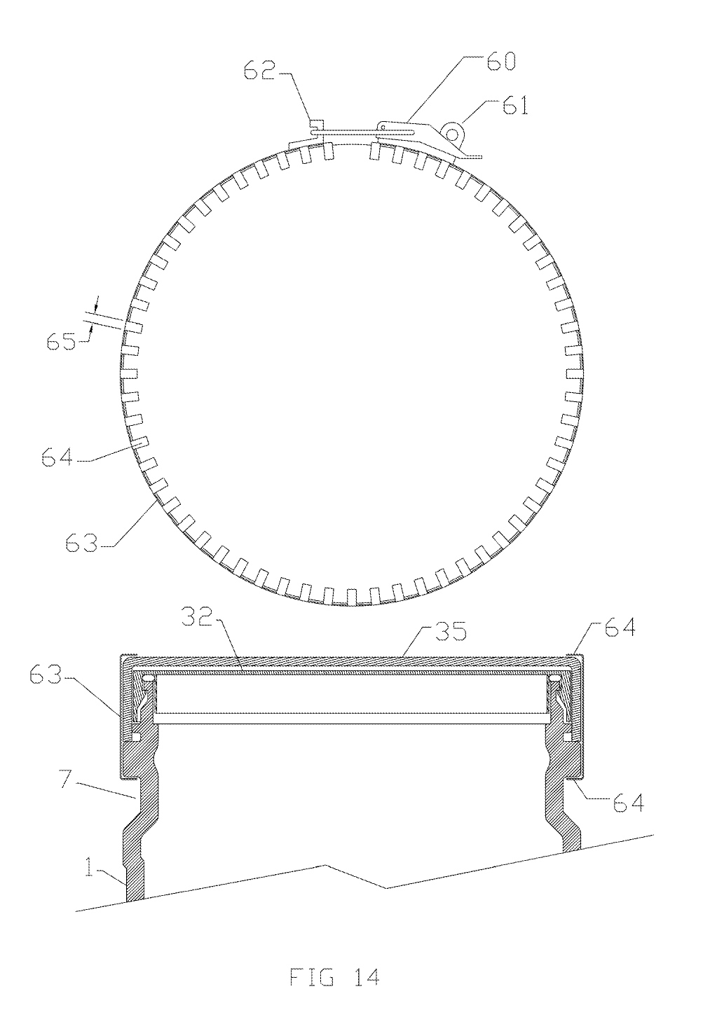

FIG. 13 shows the upper rim portion 70 of the container body 1 in sectional view and assembled with an inner lid 32, gasket 31 bearing on sealing surface 33, and outer lid 35 slip fit past protrusion 36 and bearing on the weight bearing band 59.

FIG. 14 shows a preferred embodiment the waterproof storage container together with a locking ring 63 serving to secure the outer lid 35 to the container body 1. A sheet metal strap, preferably of stainless steel, is formed with a plurality of bent tabs 64 along an upper edge to engage the top of the outer lid 35 and a lower edge to engage the top edge of the strap groove 7. The ends of the locking ring 63 are shown equipped in this preferred embodiment, one end with a latch 60 and the other end with a catch 62 allowing the two ends to be drawn together and secured with a lock by means of the hole in tab 61. The width of the tabs 65 and their spacing are adjusted to provide adequate flexibility of the locking ring 63.

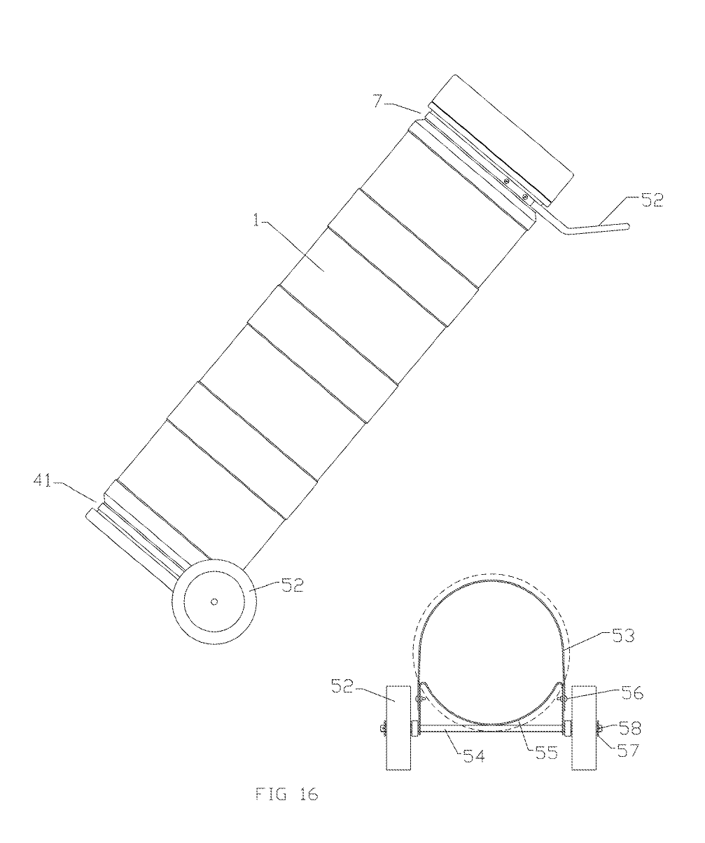

FIG. 15 shows another preferred embodiment for the storage of smaller items such as cash, documents, jewelry and handguns. In this embodiment the upper rim portion 70 and lower rim portion 71 comprise essentially all of the container body 1 resulting in an overall height along with the outer lid 35 of less than the outside dimension 4. Any number of overall height can be achieved by thus varying the overall height of the container body 1.

FIG. 16 shows preferred embodiment of the disclosed technology which includes a detachable wheel assembly. In this preferred embodiment, the detachable wheel assembly is stowable within (meaning that the detachable wheel assembly can be stored inside) within the waterproof storage container, and are assembled with minimal or no use of tools. Frame 55 and axle 54 are attached to the recess 41 and secured with strap 53 via fasteners 56 but preferably with manually engaged clamps for facilitated no-tools installation. Wheels 52 are then secured with washers 57 and clevis pins 58. A removable handle 52 is secured in a similar fashion with a strap fit to the strap groove 7. This feature facilitates transport of the waterproof storage container to or from a storage location. Of particular utility is the ability to deliver emergency supplies to distribution points and allowing for the means for subsequent facilitated transport manually to an actual point of use, storage, or subsequent staging.

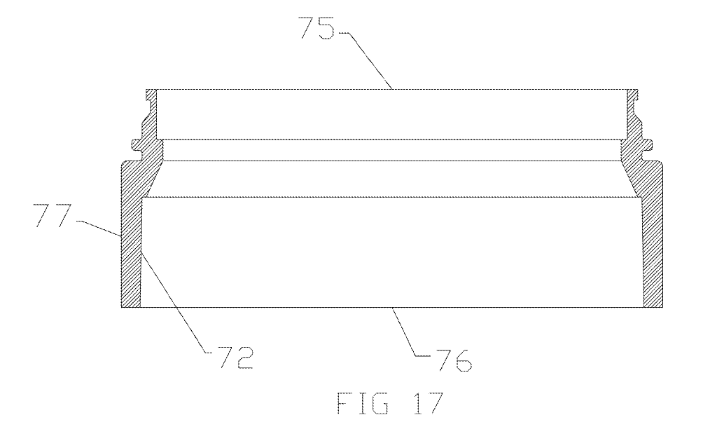

FIG. 17 shows a pipe closure device comprising a 77 of generally cylindrical form with a first open end 75 and a second open end 76 defining a through passage. The first open end 75 is configured after the form of the distal portion of the container body 1 previously discussed and for the purpose of accommodating a snap fit bucket lid or similar closure. The second open end 76 is configured with a slip fit 72 for a cylindrical form. In a preferred embodiment the first open end 75 is equipped with a threaded adapter 5 and threaded lid 6 while the second open end 76 is fitted to a section of 12″ industrial plastic pipe with a bonding agent compatible with the base materials. Thus applied, the pipe closure device effectively adapts the end of an industrial pipe for the use of standardized bucket lids for closure. This preferred embodiment is discussed further below.

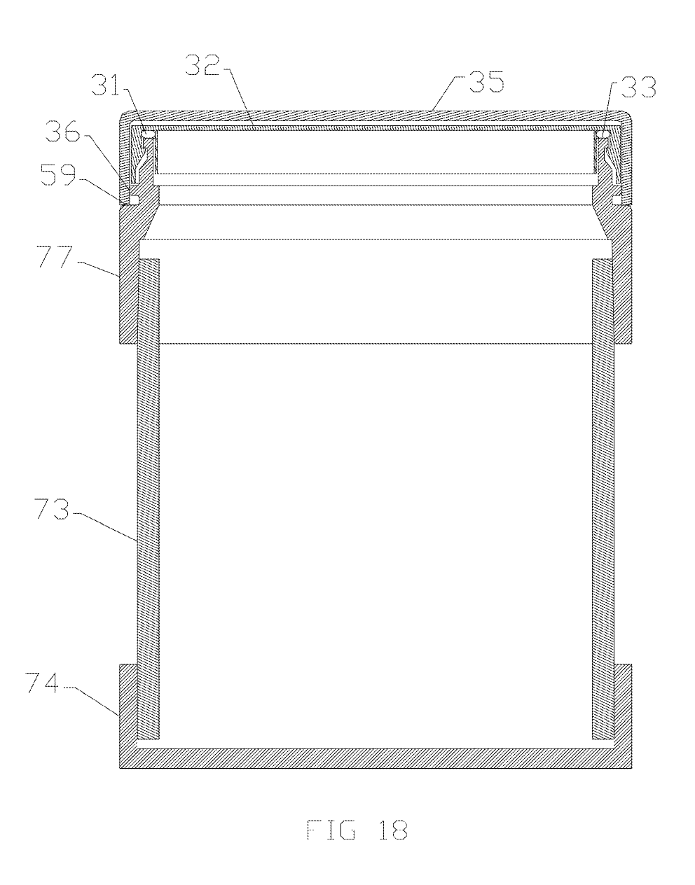

FIG. 18 shows the pipe closure device 77 discussed above used to assemble a waterproof storage container whereby the container body 1 of previously disclosed preferred embodiments is comprised of three or more components. As shown in this view, the pipe closure device 77 is attached to a first end of a cylindrical pipe section 73 while the second end of the cylindrical pipe section 73 is closed with a slip fit pipe closure 74, thus comprising an assembly functionally similar to the container body 1. The term “pipe” is used herein to refer not only to commercially available plastic industrial pipe but to any generally cylindrical tube or conduit defining a cavity open at both ends. The slip fit pipe closure 74 is in the preferred embodiment is shown as a cap but may also be a plug sealing on the inner surface of the pipe section 73. Also shown in FIG. 18 is n inner lid 32, gasket 31 compressed against sealing surface 33, and outer lid 35 slip fit over protrusion 36 and bearing on the weight bearing band 59. In a preferred embodiment, the pipe closure device 77, pipe section 73, and pipe closure 74 are of PVC (polyvinyl chloride) material or ABS (Acrylonitrile butadiene styrene) both of which materials lend themselves to solvent bonding of slip fit joints. One preferred embodiment is a pipe closure device 77 sized for a 5 gallon industrial bucket lid and 12″ plastic industrial pipe. Another preferred embodiment is a pipe closure device sized for a 2 gallon industrial bucket lid and an 8″ plastic industrial pipe.

The container body 1 in various preferred embodiments of the disclosed technology may be comprised of multiple components. One such preferred embodiment includes a separate upper rim portion 70 attached to the remaining portion of the container body 1 with a bonded slip fit of the said upper rim portion over the open end of the said remaining portion of the said container body 1. A preferred embodiment of a separate upper rim portion 70 is the pipe closure device 77 disclosed above and as seen in a preferred embodiment in FIGS. 17 and 18.

In yet another preferred embodiment both the upper rim portion 70 and the lower rim portion 71 of the container body 1 are attached to the remaining portion of the said container body 1 by slip fit joints and where said remaining portion in this preferred embodiment consists of a pipe or conduit of generally cylindrical form and with generally cylindrical ends configured to engage the said slip fit joints.

1. A waterproof storage container, comprising:
a generally cylindrical container body having substantially upright walls, said walls having an upper rim portion and a lower rim portion, said lower rim portion having a closed bottom, and said upper rim portion having an opening as wide as said container body inside diameter, and said container body having an inner surface and an outer surface;
an inner lid configured for attachment to said container body at said upper rim portion, said inner lid for removable closure of said container body;
a weight bearing band circumvolving said container body at the upper rim portion, with said weight bearing band protruding from said container body, and parallel with a plane of said closed bottom; and
an outer lid configured for placement over said upper rim portion of said container body, with a lower rim of said outer lid configured to contact said weight bearing band, so that pressure on said outer lid is transferred to said weight bearing band, and not to said inner lid.

2. The waterproof storage container of claim 1, in which said inner lid fits inside said upper rim portion by threads, and said inner lid is substantially the same diameter as said container body.

3. The waterproof storage container of claim 1 which further comprises a strap groove recessed into said container body exterior surface, suitable for attaching a lifting strap to said waterproof storage container, with said strap groove adjacent to said weight bearing band.

4. The Waterproof storage container of claim 1 where the said upper rim portion of the said container body is attached to the remaining portion of the said container body by means of a bonded slip fit and where the said remaining portion of the said container body may itself be assembled from one or more component parts.

5. A waterproof storage container, comprising:
a generally cylindrical container body having substantially upright walls, said walls having an upper rim portion and a lower rim portion, said lower rim portion having a closed bottom, and said upper rim portion having an opening substantially as wide as said waterproof storage container body inside diameter, and having an inner surface and an outer surface;
an inner lid configured for threaded attachment to said inner surface of said container body at said upper rim portion, said inner lid being substantially the same diameter as the inside diameter of the said container body, and removable from said container body;
a weight bearing band circumvolving said container body at the upper rim portion, with said weight bearing band protruding from said container body, and parallel with a plane of said closed bottom;
a strap groove recessed into said container body exterior surface, suitable for attaching a lifting strap to said waterproof storage container, with said strap groove below and adjacent to said weight bearing band; and
an outer lid configured for placement over said upper rim portion of said waterproof storage container body, with a lower rim of said outer lid configured to contact said weight bearing band, so that pressure on said outer lid is transferred to said weight bearing band, and not to said inner lid.

6. The waterproof storage container of claim 5 which further comprises a plurality of objects hanging points mounted to said inner surface of said waterproof storage container body, from which objects to be stored may be suspended.

7. The waterproof storage container of claim 5 which further comprises an interior band corresponding to said weight bearing band, with said interior and weight bearing bands providing a thickened container body region for attachment of hardware interior to said container body.

8. The waterproof storage container of claim 5 in which said upper rim portion includes a rim configured for attachment of a snap fit container lid.

9. The waterproof storage container of claim 5 in which said outer lid forms a slip fitting with said upper rim portion.

10. The waterproof storage container of claim 5 in which said inner lid is connectable to said container body at said upper rim portion by an intermediate threaded adapter snap fit to the upper rim portion of said container body whereby a threaded inner lid is removably attached to the said threaded adapter.

11. The waterproof storage container of claim 5 where said waterproof storage container body is made by the process of rotomolding.

12. The waterproof storage container of claim 5 which further comprises a wall section with one or more layers attached to the waterproof storage container body inner surface during fabrication where the outer layer of the said container body is of solid material and where at least one additional layer is of foamed material for providing improved structural properties with limited additional mass.

13. The waterproof storage container of claim 5 which further comprises a wall section with at least one additional layer where the innermost layer comprising the inner surface of said container body is of light colored material, said light colored material different than the color of the outer most layer comprising the outer surface of said container body, and each said additional layer attached to each prior applied layer during fabrication, for providing increasing visibility of objects in said waterproof storage container body.

14. The waterproof storage container of claim 5 which further comprises a locking ring with a first and a second end, a top edge and a bottom edge, with said first end attachable to said second end, and configured to circumvolve said outer lid when attached end to end, with one or more tabs on said top edge for engagement with said outer lid, and one or more tabs on said bottom edge, for engagement with said strap groove.

15. The waterproof storage container of claim 5 in which said upper rim portion includes a rim configured for attachment of a snap fit container lid said rim consisting of:
an outer protrusion circumvolving the distal portion of said upper rim portion with said outer protrusion contour established by the mold at the time that the container body is roto-molded; and
an inner surface of the distal portion of said upper rim portion with said inner surface established by a rotary cutting tool passed around the said inner surface and at a fixed distance from the outermost surface of said outer protrusion of the distal portion of said upper rim portion.

16. The waterproof storage container of claim 5 which further comprises a detachable wheel assembly comprising a pair of wheels attached to a band attachable to said waterproof storage container body.

17. The Waterproof storage container of claim 5 which further comprises:
a detachable wheel assembly which is stowable within said waterproof storage container and which detachable wheel assembly accommodates deployed attachment proximal to said lower rim portion; and
a detachable handle assembly which is stowable within said waterproof storage container and which detachable handle assembly accommodates deployed attachment proximal to said upper rim portion.

18. The Waterproof storage container of claim 5 together with a flexible and contiguous anti-corrosion bag open at one end and of dimensions substantially similar to the inside of said container body and consisting of one or more layers where the inner most layer of said anti-corrosion bag is of a polymer diffused with an outgassing anti-corrosion chemistry.

19. The Waterproof storage container of claim 5 together with a basket device removably installed within the container body, said basket device consisting minimally of a bottom surface which need not be contiguous and attached handles positioned for retrieval of said basket device.

20. The Waterproof storage container of claim 5 where the said upper rim portion and said lower rim portion of the said container body are attached to the remaining portion of the said substantially upright walls of the said container body by means of bonded slip fit joints.

21. A waterproof storage container, comprising:
an elongated container body having substantially upright walls, said walls having an upper rim portion and a lower rim portion, said lower rim portion having a closed bottom, and said upper rim portion configured for attachment of a snap fit container lid, and having an inner surface and an outer surface;
a lower groove recessed into said waterproof storage container body exterior surface proximal to said lower rim portion;
a detachable wheel assembly located by said lower groove and detachably stowable within said waterproof storage container body;
a strap groove recessed into said waterproof storage container body exterior surface proximal to said upper rim portion; and
a detachable handle assembly located by said upper groove and detachably stowable within the waterproof storage container body.

22. A pipe closure device comprising a generally cylindrical body defining a passageway open from a first end through to a second end where said first end of said device comprises a rim with a protruding outer lip and a sectional profile to accommodate a snap fit bucket lid, and where said second end of said device is sized for a slip fit over the end of a cylindrical form, such that a snap fit bucket lid may be used as an end closure for a pipe thus fitted with the device.

23. The pipe closure device as defined in claim 22 and further comprising:
a weight bearing band circumvolving said pipe closure device and with a plane perpendicular to the center axis of said passageway; and
a mating outer lid which fits over said installed snap fit bucket lid and bears on said weight bearing band and thereby transferring loads applied to the said outer lid through to the body of said pipe closure device and while substantially limiting transference of the same loads through to said snap fit bucket lid when installed.

24. The pipe closure device as defined in claim 22 together with:
a cylindrical tube with a first end and a second end where the said first end of the said cylindrical tube is attached to the said second end of the said pipe closure device;
a slip fit pipe closure attached to the said second end of said cylindrical tube; and
a said snap fit bucket lid attached to the said first end of said pipe closure device, thus together comprising a waterproof storage container.

25. A waterproof storage container, comprising:
a generally cylindrical pipe closure device defining a passageway open from a first end through to a second end;
a first end of said pipe closure device comprising a rim with an outer protrusion with a sectional profile to accommodate a snap fit bucket lid;
a second end of said pipe closure device sized for a slip fit over the end of a cylindrical form;
a cylindrical pipe with a first end and a second end where the said first end of the said cylindrical pipe is fitted to the said second end of the said pipe closure device;
a generally cylindrical vessel with a first end and a second end where the first end of said cylindrical vessel is open and sized for a slip fit over a cylindrical form and is so fitted to the said second end of the said cylindrical pipe; and
a second end of said cylindrical vessel having a closed bottom.

26. The pipe closure device as defined in claim 25 and further comprising:
a weight bearing band circumvolving said pipe closure device and with a plane perpendicular to the center axis of said passageway; and
a mating outer lid which fits over said installed snap fit bucket lid and bears on said weight bearing band and thereby transferring loads applied to the said outer lid through to the body of said pipe closure device and while substantially limiting transference of the same loads through to said snap fit bucket lid when installed.
